(19) United States
(12) Patent Application Publication
(10) Pub. No.: US 2019/0015775 A1
(43) Pub. Date: Jan. 17, 2019

(54) MEMBRANE AND METHOD FOR FILTERING GAS

(71) Applicant: Industrial Technology Research Institute, Hsinchu (TW)

(72) Inventors: Yen-Hsun CHI, Hsinchu City (TW); Chun-Ju HUANG, Zhubei City (TW); Yu-Li LIN, Chiayi City (TW)

(73) Assignee: Industrial Technology Research Institute, Hsinchu (TW)

(21) Appl. No.: 15/673,695

(22) Filed: Aug. 10, 2017

(30) Foreign Application Priority Data
Jul. 12, 2017 (TW) 106123313

(51) Int. Cl. B01D 53/22; B01D 69/10; B01D 71/02; B01D 69/12

(52) U.S. Cl. CPC B01D 53/228; B01D 69/10; B01D 2325/04; B01D 69/12; B01D 71/02

(57) ABSTRACT

A method for filtering gas includes providing a membrane, wherein the membrane includes a porous support, a hydrogen permeation layer on the porous support, and a calcinated layered double hydroxide (c-LDH) layer on the hydrogen permeation layer. The method also provides a hydrogen-containing mixture gas on the c-LDH layer, and collects hydrogen under the porous support, in which the hydrogen sequentially permeates through the c-LDH layer, the hydrogen permeation layer, and the porous support.

### CROSS REFERENCE TO RELATED APPLICATIONS

The present application is based on, and claims priority from, Taiwan Application Serial Number 106123313, filed on July 12, the disclosure of which is hereby incorporated by reference herein in its entirety.

### TECHNICAL FIELD

The technical field relates to a purification of hydrogen, and in particular it relates to a membrane for such purification.

### BACKGROUND

The use of gas formed of fossil fuels that can be used for producing hydrogen is one of the most important skills in the generation of hydrogen energy. However, all research and development into fossil fuel-formed gas for producing hydrogen eventually encounters the problem of how to separate impurities from the hydrogen. Pressure-swing absorption, freezing, alloy absorption, and other techniques can be employed to remove these impurities, but these purification methods depend on the nature of the impurities. Although the methods may form filtered hydrogen of high purity, the mechanisms of the methods are complex and expensive. Among such methods, membrane separation used for filtering hydrogen has the advantage of a simple structure, in which the hydrogen permeation layer directly serves as a sieve mesh to separate hydrogen from a mixture gas. However, some compositions (e.g. carbon monoxide, carbon dioxide, and methane) of the mixture atmosphere produced by the reformer are toxic to the hydrogen permeation layer, and these toxic compositions may negatively influence the long-term stability of the hydrogen permeation layer used for purifying the hydrogen. Regarding energy efficiency, the hydrogen-containing gas produced by the reformer (with a hydrogen concentration of about 60% to 70%) and the industrial residual gas (with a hydrogen concentration less than 50%) cannot achieve the substantial benefit. Relevant local manufacturers have found that the low hydrogen concentration of available sources is a major obstruction in the development of practical hydrogen energy and recycling. As such, the membrane for separating and purifying hydrogen should be improved to increase its practicality, and the improvement will be beneficial in promoting the use of hydrogen energy.

### SUMMARY

One embodiment of the disclosure provides a membrane, including a porous support, a hydrogen permeation layer on the porous support, and a calcinated layered double hydroxide (c-LDH) layer on the hydrogen permeation layer.

One embodiment of the disclosure provides a method for filtering gas. The method includes providing a membrane that includes a porous support, a hydrogen permeation layer on the porous support; and a calcinated layered double hydroxide (c-LDH) layer on the hydrogen permeation layer. The method also includes providing a hydrogen-containing mixture gas on the c-LDH layer, and collecting hydrogen under the porous support. The hydrogen sequentially permeates through the c-LDH layer, the hydrogen permeation layer, and the porous support.

A detailed description is given in the following embodiments with reference to the accompanying drawings.

### BRIEF DESCRIPTION OF THE DRAWINGS

The disclosure can be more fully understood by reading the subsequent detailed description and examples with references made to the accompanying drawings, wherein:

FIG. 1 shows a membrane in embodiments.

FIGS. 2A to 2D show microscopic photographs of the surface of the membranes in the embodiments.

FIGS. 3A to 3D show microscopic photographs of the cross-section of the membranes in the embodiments.

FIG. 4 shows hydrogen permeation rates of hydrogen at different temperatures permeating through the membrane in one embodiment.

FIG. 5 shows selectivities of hydrogen and nitrogen at different temperatures permeating through the membrane in one embodiment.

FIG. 6 shows the carbon monoxide concentration of methanol-reformed gas after permeating through the membrane in one embodiment.

FIG. 7 shows the methane concentration of methanol-reformed gas after permeating through the membrane in one embodiment.

FIG. 8 shows a comparison of hydrogen flux of hydrogen permeating through the membrane and nitrogen flux of nitrogen permeating through the membrane, in which the methanol-reformed gas permeates through the membrane for a long time before measuring the hydrogen flux and the nitrogen flux.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

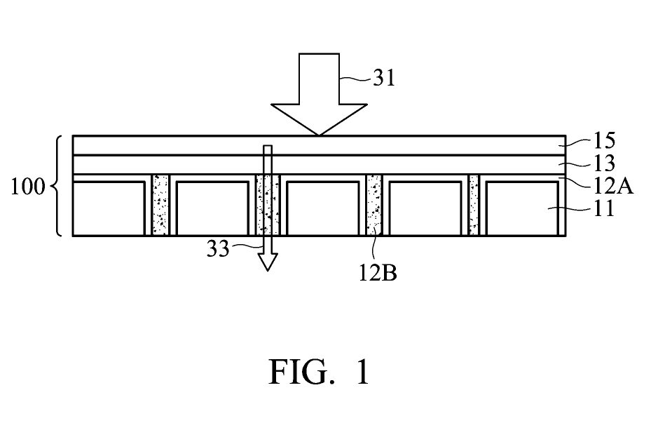

In one embodiment of the disclosure, a membrane 100 is provided as shown in FIG. 1. The membrane 100 includes a porous support 11, a hydrogen permeation layer 13 on the porous support 11, and a calcinated layered double hydroxide (c-LDH) layer 15 on the hydrogen permeation layer 13. In one embodiment, the porous support 11 includes stainless steel, ceramic, or glass, and pores of the porous support 11 have a size of 1 micrometer to 100 micrometers. If the pores in the porous support 11 are too small, this may result in an overly low total gas flux. If the pores of the porous support 11 are too large, an overly thick hydrogen permeation layer is needed to cover the pores, thereby reducing the practicability of the membrane, because too thick a hydrogen permeation layer costs a lot and has too low a hydrogen flux. In general, the ceramic and glass have a more regular pore size and pore distribution, but it is difficult to integrate a ceramic or glass support with other components due to the lower processability of the ceramic and glass. Stainless steel can easily be integrated with other components, but it has a less uniform pore size and pore distribution.

Alternatively, the surface of the stainless steel porous support can be modified to mitigate the problem of non-uniform pores, and reduce the desired thickness of the subsequently formed hydrogen permeation layer. For example, the surface of the porous support 11 can be wrapped by an LDH layer, which can then be calcinated to form a calcinated LDH (c-LDH) layer 12A. The LDH layer can be formed by co-precipitation, hydrothermal synthesis, ionic exchange, or a combination thereof. The LDH layer can be calcinated at 300° C. to 450° C. under ambient pressure and ambient atmosphere. If the LDH layer is calcinated at an overly low temperature, the water and hydroxyl ion in the interlayer of the LDH layer will not be removed, which may block the hydrogen permeation and lower the hydrogen permeation rate. If the LDH layer is calcinated at an overly high temperature, the stainless steel may soften and deform. In one embodiment, the c-LDH layer 12A has a thickness of 1 micrometer to 10 micrometers. An overly thin c-LDH layer 12A has no protective effect. An overly thick c-LDH layer 12A may increase the cost. In addition, pores of the porous support 11 can be filled by filling particles 12B with a particle size of 1 micrometer to 30 micrometers. The filling particles 12 can be made of aluminum oxide, silicon oxide, calcium oxide, cerium oxide, titanium oxide, chromium oxide, manganese oxide, iron oxide, nickel oxide, copper oxide, zinc oxide, zirconium oxide, or a combination thereof. Filling particles 12B that are too small cannot efficiently fulfill the pores of the porous support 11. Filling particles 12B that are too large cannot fit the pores of the porous support 11. Alternatively, the pores of the porous support 11 can be filled by the filling particles 12B. Subsequently, the porous support 11 is then wrapped by the LDH layer, and the LDH layer is then calcinated to form the c-LDH layer 12A as described above.

Thereafter, the hydrogen permeation layer 13 is formed on the porous support 11. In one embodiment, the hydrogen permeation layer 13 includes palladium, silver, copper, gold, nickel, platinum, aluminum, gallium, indium, thallium, germanium, tin, lead, antimony, bismuth, the like, or a combination thereof. The hydrogen permeation layer 13 can be formed by electroless plating, sputtering, physical vapor deposition, or another suitable process. In one embodiment, the hydrogen permeation layer 13 has a thickness of 1 micrometer to 100 micrometers. In one embodiment, the hydrogen permeation layer 13 has a thickness of 5 micrometers to 10 micrometers. If the hydrogen permeation layer 13 is too thin, its ability to purify hydrogen at high temperatures after long-term use may be compromised, due to defects that occur during use. Using a hydrogen permeation layer 13 that is too thick will not only reduce the hydrogen flux but also increase the cost.

Thereafter, the surface of the hydrogen permeation layer 13 is wrapped by an LDH layer, and the LDH layer is then calcinated to form the c-LDH layer 15. The LDH layer can be formed by co-precipitation, hydrothermal synthesis, ionic exchange, or a combination thereof. The LDH layer can be calcinated at 350° C. to 500° C. under ambient pressure and an ambient atmosphere. If the LDH layer is calcinated at too low a temperature, the water and hydroxyl ion in the interlayer of the LDH layer will not be removed, which may block hydrogen permeation and lower the hydrogen permeation rate. If the LDH layer is calcinated at too high a temperature, the stainless steel may soften and deform. In one embodiment, the c-LDH layer 15 has a thickness of 1 micrometer to 50 micrometers. In one embodiment, the c-LDH layer 15 has a thickness of 5 micrometers to 20 micrometers. A c-LDH layer 15 that is too thin has no protective effect. A c-LDH layer 15 that is too thick may increase the cost. In one embodiment, the c-LDH layer 15 has an interlayer spacing of 2.89 Å to 3.64 Å. Interlayer spacing that is too short may reduce the hydrogen flux of the mixture gas permeating through the membrane 100. Interlayer spacing that is too long may lower the hydrogen purity of the gas permeating through the membrane 100.

In one embodiment, the c-LDH layer 12A (wrapping the stainless steel porous support 11) and the c-LDH layer 15 (wrapping the hydrogen permeation layer 13) are the same. Alternatively, the c-LDH layer 12A (wrapping the stainless steel porous support 11) and the c-LDH layer 15 (wrapping the hydrogen permeation layer 13) are different. The LDH has a chemical structure of [M^{II}₁₋ₓM^{III}ₓ(OH)₂]Aⁿ⁻_{x/n}.mH₂O, wherein M^{II} is Mg²⁺, Zn²⁺, Fe²⁺, Ni²⁺, Co²⁺, or Cu²⁺; M^{III} is Al³⁺, Cr⁺, Fe³⁺, or Sc³⁺; Aⁿ⁻ is CO₃²⁻, Cl⁻, NO₃⁻, SO₄²⁻, PO₄³⁻, or C₆H₄(COO⁻)₂; and x is 0.2 to 0.33. Part or all of M^{II} can be replaced with Li⁺. For example, the LDH layer can be an LDH of Li and Al. In one embodiment, the c-LDH layers 12A and 15 contain the CO₃²⁻ functional group to achieve the desired interlayer spacing.

In one embodiment, the membrane 100 can be used to filter gas. For example, hydrogen-containing mixture gas 31 (e.g. methanol-reformed gas) can be provided on the c-LDH layer 15, and hydrogen 33 can be collected under the porous support 11. The hydrogen 33 in the mixture gas 31 may sequentially permeate through the c-LDH layer 15, the hydrogen permeation layer 13, and the porous support 11. In one embodiment, the gas collected under the porous support 11 may have a hydrogen concentration (purity) over 99%. The c-LDH layer 15 formed on the hydrogen permeation layer 13 would not lower the hydrogen flux of the membrane 100, and largely increase the selectivity of hydrogen and other gas of the membrane 100. In addition, the membrane 100 may keep its original effect of purification after long-term use (long-term stability).

Below, exemplary embodiments will be described in detail with reference to accompanying drawings so as to be easily realized by a person having ordinary knowledge in the art. The inventive concept may be embodied in various forms without being limited to the exemplary embodiments set forth herein. Descriptions of well-known parts are omitted for clarity, and like reference numerals refer to like elements throughout.

### EXAMPLES

### Preparation Example 1

AlLi intermetallic compound was ground to powder with a particle size of 100 micrometers to 1000 micrometers. The AlLi intermetallic compound has a Li content of about 18 wt % to 21 wt %. The AlLi intermetallic compound powder was put into 100 mL of pure water, which was bubbled by nitrogen and stirred under ambient atmosphere for several minutes, such that most of the AlLi intermetallic compound powder reacted with the water and dissolved in the water. The above solution was filtered by a filter paper (No. 5A) to remove impurities, thereby obtaining a clean alkaline solution containing Li⁺ and Al³⁺. The alkaline solution had a pH value of about 11.0 to 12.3. The alkaline solution was analyzed by inductively coupled plasma-atomic emission spectrometry (ICP-AES) to determine its Li⁺ concentration (about 146±37 ppm) and Al³⁺ concentration (about 185±13 ppm).

A porous stainless steel (PSS, Pall Accusep Filter, Filter P/N: 7CC6L465236235SC02) was received, and each of the pores of the PSS surface was filled with aluminum oxide particles with an average particle size of 10 micrometers. The PSS filled with the aluminum oxide particles was immersed in the alkaline solution (containing Li⁺ and Al³⁺) for 2 hours and then dried, such that a lithium-containing aluminum hydroxide layer with a continuous phase, a layered double hydroxide (LDH) structure, and a sufficient thickness was formed on the PSS surface (LDH/PSS). The LDH layer had a thickness of about 3 micrometers. Thereafter, the LDH/PSS was calcinated at 450° C. for 2 hours to form c-LDH/PSS. The PSS having pores filled with the aluminum oxide and wrapped by the c-LDH layer (c-LDH/PSS) may be referred to as a porous support.

Subsequently, a palladium layer was formed on the c-LDH layer in the following steps. The c-LDH/PSS was sequentially immersed in a SnCl₂ solution, de-ionized water, a PdCl₂ solution, 0.01M HCl, and de-ionized water, and the above steps were repeated until the color of the sample surface changed to brown, signifying that the c-LDH/PSS was activated. The activated c-LDH/PSS was put into a palladium solution to perform electroless plating, thereby forming a palladium layer on the c-LDH to complete a Pd/c-LDH/PSS membrane. The palladium layer had a thickness of about 11.5 micrometers.

### Comparative Example 1

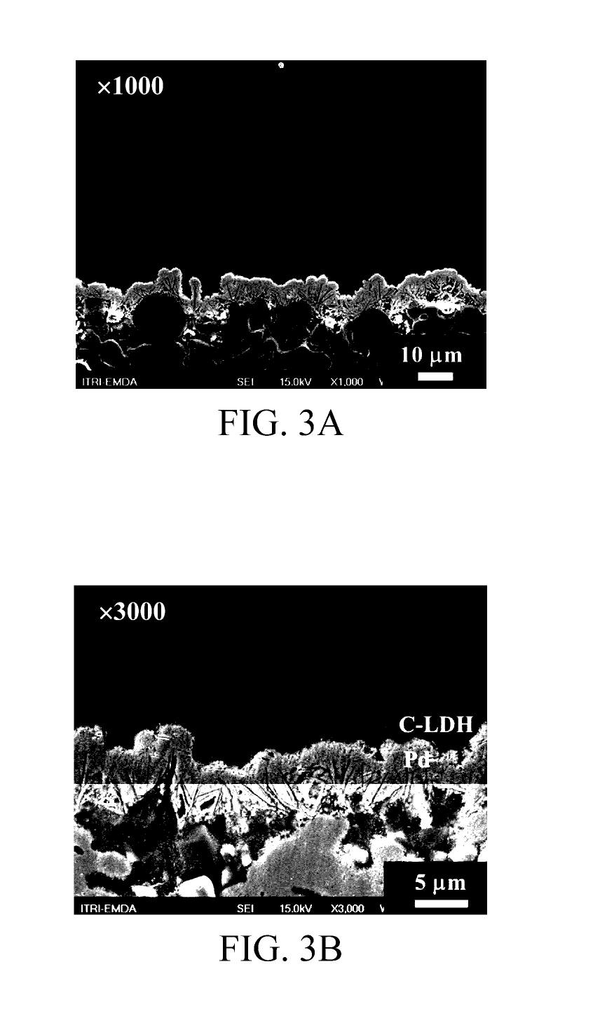

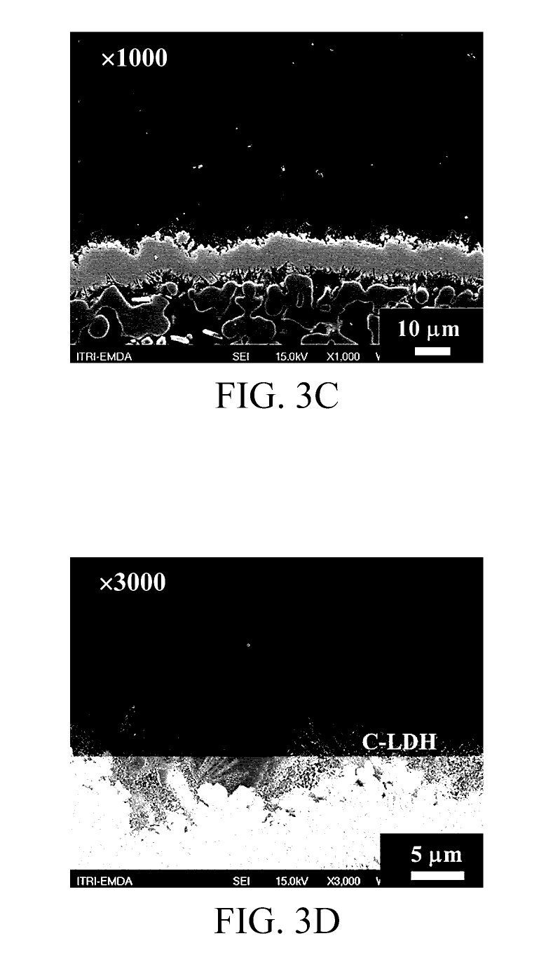

In a chamber, hydrogen was provided on the palladium layer (Pd) of the Pd/c-LDH/PSS membrane in Preparation Example 1, and the pressure of the hydrogen was increased to 4 atm. As such, the hydrogen flux (at 4 atm) of the hydrogen permeating through the Pd/c-LDH/PSS membrane was measured under the PSS of the Pd/c-LDH/PSS membrane by a flow meter. The hydrogen fluxes at different pressures were regression calculated to obtain the hydrogen permeation rate of the hydrogen permeating through the Pd/c-LDH/PSS membrane. Next, the chamber pressure was reduced to ambient pressure, and nitrogen was provided on the Pd layer of the Pd/c-LDH/PSS membrane to drive out hydrogen. After the chamber was full of nitrogen, the pressure of the nitrogen on the Pd layer of the Pd/c-LDH/PSS membrane was increased to 4 atm. As such, the nitrogen flux (at 4 atm) of the nitrogen permeating through the Pd/c-LDH/PSS membrane was measured under the PSS of the Pd/c-LDH/PSS membrane by a flow meter. The hydrogen permeation rates of the Pd/c-LDH/PSS membrane at different temperatures were shown in FIG. 4. The H₂/N₂ selectivities (hydrogen flux/nitrogen flux) of the Pd/c-LDH/PSS membrane at different temperatures were shown in FIG. 5. The membrane had a hydrogen permeation rate of 74 Nm³/m².hr-atm^{0.5} to 85 Nm³/m².hr-atm^{0.5}, and a H₂/N₂ selectivity of 3549 to 4205.

### Preparation Example 2

AlLi intermetallic compound was ground to powder with a particle size of 100 micrometers to 1000 micrometers. The AlLi intermetallic compound has a Li content of about 18 wt % to 21 wt %. The AlLi intermetallic compound powder was put into 100 mL of pure water, which was bubbled by nitrogen and stirred under ambient atmosphere for several minutes, such that most of the AlLi intermetallic compound powder reacted with the water and dissolved in the water. The above solution was filtered by a filter paper (No. 5A) to remove impurities, thereby obtaining a clean alkaline solution containing Li⁺ and Al³⁺. The alkaline solution had a pH value of about 11.0 to 12.3. The alkaline solution was analyzed by ICP-AES to determine its Li⁺ concentration (about 146±37 ppm) and Al³⁺ concentration (about 185±13 ppm).

A porous stainless steel (PSS, Pall Accusep Filter, Filter P/N: 7CC6L465236235SC02) was received, and each of the pores of the PSS surface was filled with aluminum oxide particles with an average particle size of 10 micrometers. The PSS filled with the aluminum oxide particles was immersed in the alkaline solution (containing Li⁺ and A³⁺) for 2 hours and then dried, such that a lithium-containing aluminum hydroxide layer with a continuous phase, a layered double hydroxide (LDH) structure, and a sufficient thickness was formed on the PSS surface (LDH/PSS). The LDH layer had a thickness of about 3 micrometers. Thereafter, the LDH/PSS was calcinated at 450° C. for 2 hours to form c-LDH/PSS. The PSS having pores filled with the aluminum oxide and wrapped by the c-LDH layer (c-LDH/PSS) may be referred to as a porous support.

Subsequently, a palladium layer was formed on the c-LDH layer in the following steps. The c-LDH/PSS was sequentially immersed in a SnCl₂ solution, de-ionized water, a PdCl₂ solution, 0.01M HCl, and de-ionized water, and the above steps were repeated until the color of the sample surface changed to brown, signifying that the c-LDH/PSS was activated. The activated c-LDH/PSS was put into a palladium solution to perform electroless plating, thereby forming a palladium layer on the c-LDH to complete a Pd/c-LDH/PSS structure. The palladium layer had a thickness of about 11.5 micrometers.

1800 mL of de-ionized water was bubbled by nitrogen and stirred to avoid dissolving carbon dioxide in the water. AlLi intermetallic compound was pound, cracked, and then filtered by a sieve mesh (#325, pore size of 45 micormeters). 1.8 g of the filtered AlLi was added to the bubbled de-ionized water, which was then continuously bubbled and stirred for 20 minutes. The un-dissolved powder was filtered out by filter paper to obtain a front solution of LDH. The front solution was analyzed by ICP-AES to determine its Li⁺ concentration (about 146±37 ppm) and Al³⁺ concentration (about 185±13 ppm).

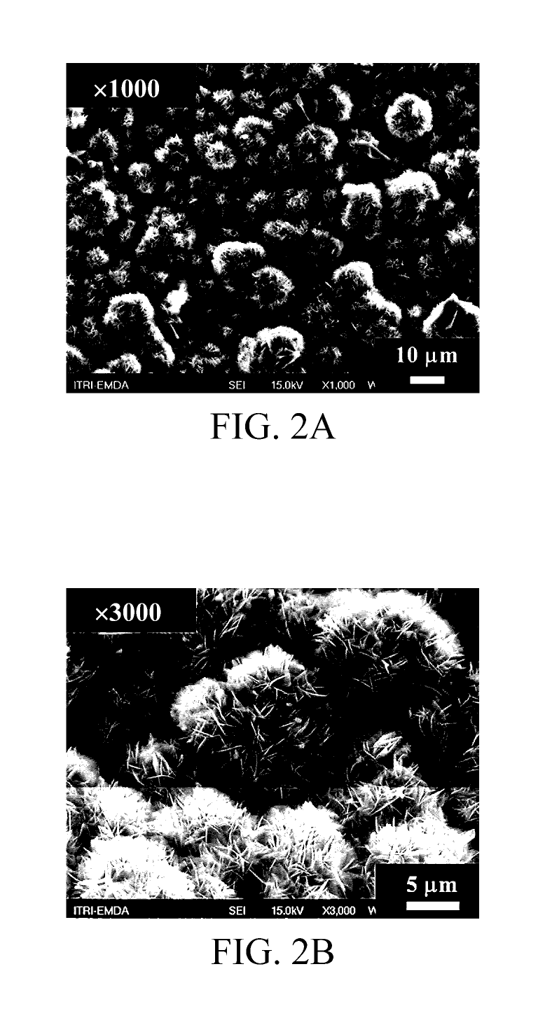

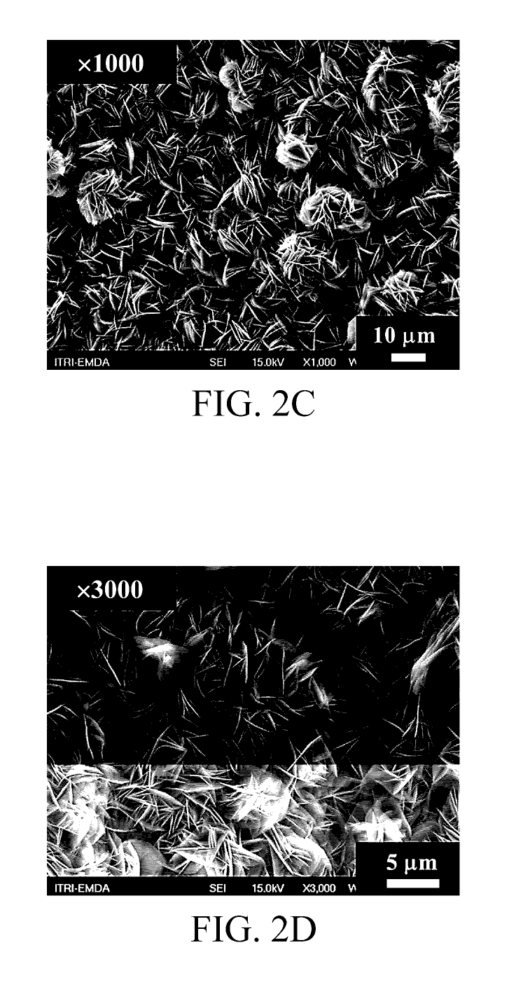

Thereafter, the Pd/c-LDH/PSS structure was immersed in the front solution of LDH at 30 for 2 hours, then washed with de-ionized water, and then baked and calcinated at 400° C. to complete a c-LDH/Pd/c-LDH/PSS membrane (HP405). The microscopic photographs of the surface of the membrane are shown in FIG. 2A (×1000) and FIG. 2B (×3000), and the microscopic photographs of the cross-section of the membrane are shown in FIG. 3A (×1000) and FIG. 3B (×3000). The microscopic photographs were obtained by the microscope JEOL JSM-6500F.

### Preparation Example 3

AlLi intermetallic compound was ground to powder with a particle size of 100 micrometers to 1000 micrometers. The AlLi intermetallic compound has a Li content of about 18 wt % to 21 wt %. The AlLi intermetallic compound powder was put into 100 mL of pure water, which was bubbled by nitrogen and stirred under ambient atmosphere for several minutes, such that most of the AlLi intermetallic compound powder reacted with the water and dissolved in the water. The above solution was filtered by a filter paper (No. 5A) to remove impurities, thereby obtaining a clean alkaline solution containing Li⁺ and Al³⁺. The alkaline solution had a pH value of about 11.0 to 12.3. The alkaline solution was analyzed by ICP-AES to determine its Li⁺ concentration (about 146±37 ppm) and Al³⁺ concentration (about 185±13 ppm).

A porous stainless steel (PSS, Pall Accusep Filter, Filter P/N: 7CC6L465236235SC02) was received, and each of the pores of the PSS surface was filled with aluminum oxide particles with an average particle size of 10 micrometers. The PSS filled with the aluminum oxide particles was immersed in the alkaline solution (containing Li⁺ and Al³⁺) for 2 hours and then dried, such that a lithium-containing aluminum hydroxide layer with a continuous phase, a layered double hydroxide (LDH) structure, and a sufficient thickness was formed on the PSS surface (LDH/PSS). The LDH layer had a thickness of about 3 micrometers. Thereafter, the LDH/PSS was calcinated at 450° C. for 2 hours to form c-LDH/PSS. The PSS having pores filled with the aluminum oxide and wrapped by the c-LDH layer (c-LDH/PSS) may be referred to as a porous support.

Subsequently, a palladium layer was formed on the c-LDH layer in the following steps. The c-LDH/PSS was sequentially immersed in a SnCl₂ solution, de-ionized water, a PdCl₂ solution, 0.01M HCl, and de-ionized water, and the above steps were repeated until the color of the sample surface changed to brown, signifying that the c-LDH/PSS was activated. The activated c-LDH/PSS was put into a palladium solution to perform electroless plating, thereby forming a palladium layer on the c-LDH to complete a Pd/c-LDH/PSS structure. The palladium layer had a thickness of about 11.5 micrometers.

1800 mL of de-ionized water was bubbled by nitrogen and stirred to avoid dissolving carbon dioxide in the water. AlLi intermetallic compound was pound, cracked, and then filtered by a sieve mesh (#325, pore size of 45 micrometers). 1.8 g of the filtered AlLi was added to the bubbled de-ionized water, which was then continuously bubbled and stirred for 20 minutes. The un-dissolved powder was filtered out by filter paper to obtain a front solution of LDH. The front solution was analyzed by ICP-AES to determine its Li⁺ concentration (about 146±37 ppm) and Al³ concentration (about 185±13 ppm).

Thereafter, the Pd/c-LDH/PSS structure was immersed in the front solution of LDH at 30 for 2 hours, then washed with de-ionized water, and then baked and calcinated at 400° C. to complete a c-LDH/Pd/c-LDH/PSS membrane (HP537). Preparation Example 2 and Preparation Example 3 were different in their porous stainless steel, in which the pore distributions and pore sizes of the two examples of porous stainless steel were slightly different (even with the same Serial No. from the same supplier).

### Preparation Example 4

AlLi intermetallic compound was ground to powder with a particle size of 100 micrometers to 1000 micrometers. The AlLi intermetallic compound has a Li content of about 18 wt % to 21 wt %. The AlLi intermetallic compound powder was put into 100 mL of pure water, which was bubbled by nitrogen and stirred under ambient atmosphere for several minutes, such that most of the AlLi intermetallic compound powder reacted with the water and dissolved in the water. The above solution was filtered by a filter paper (No. 5A) to remove impurities, thereby obtaining a clean alkaline solution containing Li⁺ and Al³⁺. The alkaline solution had a pH value of about 11.0 to 12.3. The alkaline solution was analyzed by ICP-AES to determine its Li⁺ concentration (about 146±37 ppm) and Al³⁺ concentration (about 185±13 ppm).

A porous stainless steel (PSS, Pall Accusep Filter, Filter P/N: 7CC6L465236235SC02) was received, and each of the pores of the PSS surface was filled with aluminum oxide particles with an average particle size of 10 micrometers. The PSS filled with the aluminum oxide particles was immersed in the alkaline solution (containing Li⁺ and Al³⁺) for 2 hours and then dried, such that a lithium-containing aluminum hydroxide layer with a continuous phase, a layered double hydroxide (LDH) structure, and a sufficient thickness was formed on the PSS surface (LDH/PSS). The LDH layer had a thickness of about 3 micrometers. Thereafter, the LDH/PSS was calcinated at 450° C. for 2 hours to form c-LDH/PSS. The PSS having pores filled with the aluminum oxide and wrapped by the c-LDH layer (c-LDH/PSS) may be referred to as a porous support.

Subsequently, a palladium layer was formed on the c-LDH layer in the following steps. The c-LDH/PSS was sequentially immersed in a SnCl₂ solution, de-ionized water, a PdCl₂ solution, 0.01M HCl, and de-ionized water, and the above steps were repeated until the color of the sample surface changed to brown, signifying that the c-LDH/PSS was activated. The activated c-LDH/PSS was put into a palladium solution to perform electroless plating, thereby forming a palladium layer on the c-LDH to complete a Pd/c-LDH/PSS structure. The palladium layer had a thickness of about 11.5 micrometers.

1800 mL of de-ionized water was bubbled by nitrogen and stirred to avoid dissolving carbon dioxide in the water. AlLi intermetallic compound was pound, cracked, and then filtered by a sieve mesh (#325, pore size of 45 micrometers). 1.8 g of the filtered AlLi was added to the bubbled de-ionized water, which was then continuously bubbled and stirred for 20 minutes. The un-dissolved powder was filtered out by filter paper to obtain a front solution of LDH. The front solution was analyzed by ICP-AES to determine its Li⁺ concentration (about 146±37 ppm) and Al³ concentration (about 185±13 ppm).

Thereafter, the Pd/c-LDH/PSS structure was immersed in the front solution of LDH at 30 for 2 hours, then washed with de-ionized water, and then baked. The above steps (e.g. immersion, wash, and bake) were repeated for 3 times, and the sample was then calcinated at 400° C. to complete a c-LDH/Pd/c-LDH/PSS membrane. The microscopic photographs of the surface of the membrane are shown in FIG. 2C (×1000) and FIG. 2D (×3000), and the microscopic photographs of the cross-section of the membrane are shown in FIG. 3C (×1000) and FIG. 3D (×3000). The microscopic photographs were obtained by the microscope JEOL JSM-6500F.

### Example 1

The hydrogen flux and H₂/N₂ selectivity of the membrane HP405 (Preparation Example 2) were measured as described below. In a chamber, hydrogen of 4 atm and 400° C. was provided on the c-LDH of the membrane HP405 for 24 hours, and the hydrogen flux (at 4 atm) of the hydrogen permeating through the membrane HP405 was measured under the PSS of the membrane HP405 by a flow meter. Next, the chamber pressure was reduced to ambient pressure, and nitrogen was provided on the c-LDH of the membrane HP405 to drive out hydrogen. After the chamber was full of nitrogen, the pressure of the nitrogen on the c-LDH layer of the membrane HP405 was increased to 4 atm. As such, the nitrogen flux (at 4 atm) of the nitrogen permeating through the membrane HP405 was measured under the PSS of the membrane HP405 by a flow meter. The above steps (e.g. providing hydrogen for 24 hours and providing nitrogen) were repeated to measure the hydrogen flux and the nitrogen flux. As such, the hydrogen flux and the H₂/N₂ selectivity (defined as hydrogen flux/nitrogen flux) of the membrane HP405 after long-term operation were obtained. As shown in Table 1, the membrane HP405 still had a similar purification effect after long-term operation at 400° C. It shows that the membrane HP405 has long-term stability.

TABLE 1

| Days | Hydrogen flux (Nm³/m² · hr) | Selectivity (H₂/N₂) |
|---|---|---|
| 1 | 100 | 11818 |
| 2 | 100 | 10669 |
| 3 | 99 | 10710 |
| 4 | 100 | 10661 |
| 5 | 100 | 10797 |
| 6 | 99 | 10118 |

### Example 2

The hydrogen flux of hydrogen at different temperatures permeating the membrane HP537 (Preparation Example 3), and the nitrogen flux of the nitrogen at different temperature permeating the membrane HP537 were measured as described below. In a chamber, hydrogen was provided on the c-LDH of the membrane HP537, and the pressure of the hydrogen was increased to 4 atm. As such, the hydrogen flux (at 4 atm) of the hydrogen permeating through the membrane HP537 was measured under the PSS of the membrane HP537 by a flow meter. The hydrogen fluxes at different pressures were regression calculated to obtain the hydrogen permeation rate of the hydrogen permeating through the Pd/c-LDH/PSS membrane. Next, the chamber pressure was reduced to ambient pressure, and nitrogen was provided on the c-LDH of the membrane HP537 to drive out hydrogen. After the chamber was full of nitrogen, the pressure of the nitrogen on the c-LDH layer of the membrane HP537 was increased to 4 atm. As such, the nitrogen flux (at 4 atm) of the nitrogen permeating through the membrane HP537 was measured under the PSS of the membrane HP537 by a flow meter. The hydrogen temperature and the nitrogen temperature were changed to measure the hydrogen permeation rate at different temperatures (FIG. 4) and the H₂/N₂ selectivity at different temperatures (FIG. 5, hydrogen flux/nitrogen flux) of the membrane HP537. As shown in FIG. 4, the c-LDH wrapping on the Pd layer could slightly enhance the hydrogen permeation rate of the membrane. As shown in FIG. 5, the c-LDH wrapping on the Pd layer could largely increase the H₂/N₂ selectivity, signifying that the hydrogen ratio of the mixture gas permeating through the c-LDH/Pd/c-LDH/PSS membrane could be largely increased. The membrane HP537 had a hydrogen permeation rate of 75 Nm³/m².hr.atm⁵ to 88 Nm³/m².hr.atm^{° 5}, and a H₂/N₂ selectivity of 17688 to 23271.

### Example 3

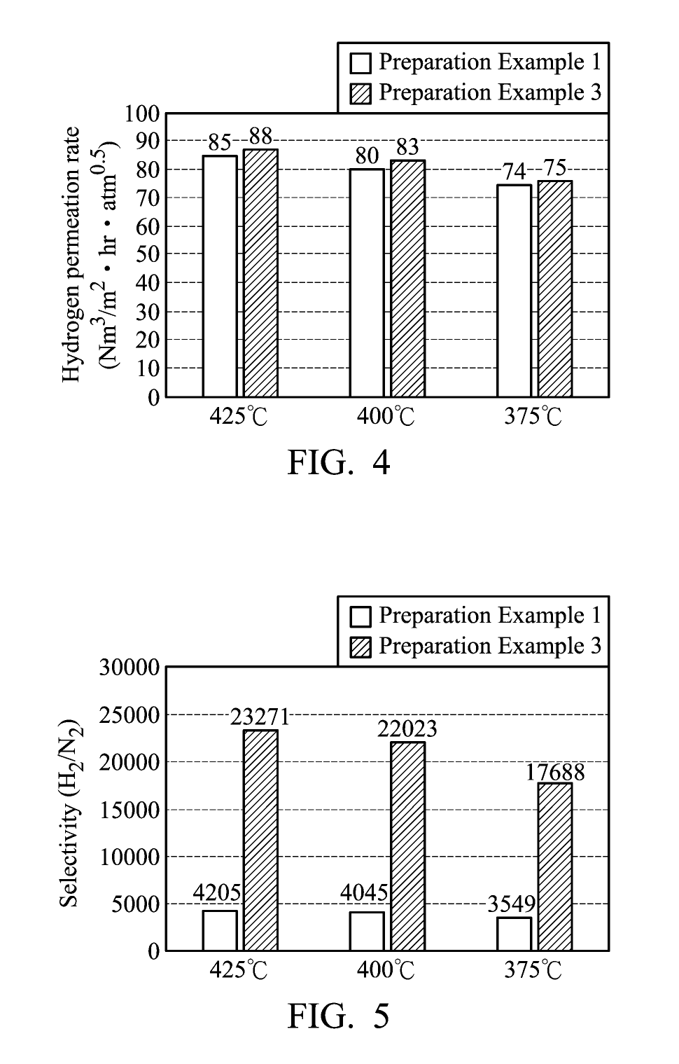

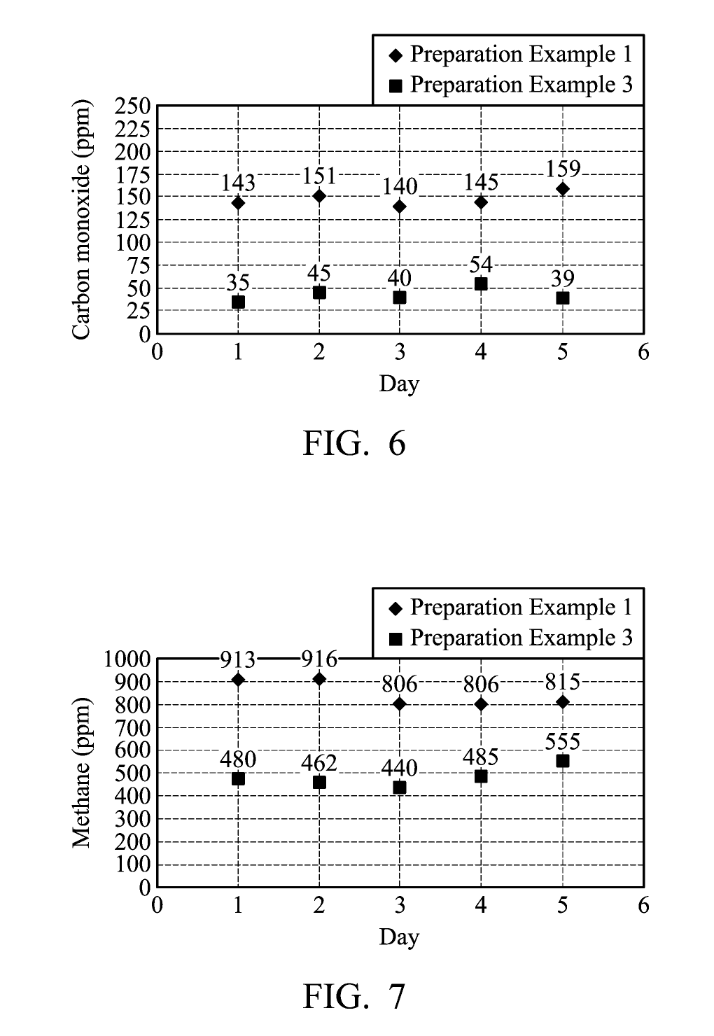

The membrane in Preparation Example 1 and the membrane HP537 in Preparation Example 3 were selected to measure the gas composition of methanol-reformed gas after permeating through the membranes. In a chamber, methanol-reformed gas (composed of 0.15% of CH₄, 0.80% of CO, 24.58% of CO₂, and 74.47% of H₂) of 400° C. and 4 atm was provided on the Pd of the Pd/c-LDH/PSS membrane in Preparation Example 1. The carbon monoxide concentration (FIG. 6) and the methane concentration (FIG. 7) of the methanol-reformed gas after permeating through the Pd/c-LDH/PSS membrane were measured under the PSS of the Pd/c-LDH/PSS membrane. In a chamber, methanol-reformed gas (composed of 0.15% of CH₄, 0.80% of CO, 24.58% of CO₂, and 74.47% of H₂) of 400° C. and 4 atm was provided on the c-LDH of the membrane HP537 in Preparation Example 3. The carbon monoxide ratio (FIG. 6) and the methane ratio (FIG. 7) of the methanol-reformed gas after permeating through the membrane HP537 were measured under the PSS of the membrane HP537. As shown in FIG. 6, the membrane HP537 with the Pd layer wrapped by the c-LDH could efficiently block the carbon monoxide, e.g. the carbon monoxide concentration was reduced from 140 ppm to 159 ppm (Preparation Example 1) to 35 ppm to 54 ppm (Preparation Example 3). As shown in FIG. 7, the membrane HP537 with the Pd layer wrapped by the c-LDH could also efficiently block the methane, e.g. the methane concentration was reduced from 806 ppm to 913 ppm (Preparation Example 1) to 440 ppm to 555 ppm (Preparation Example 3).

### Example 4

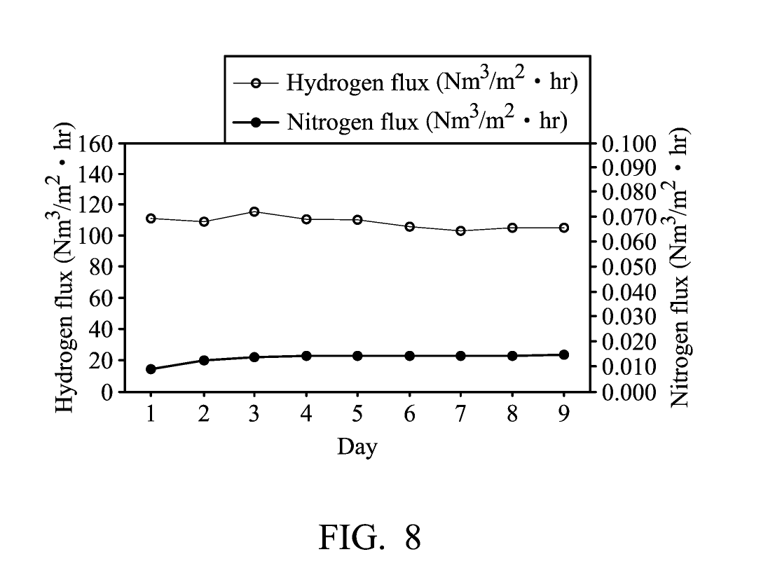

The membrane HP537 in Preparation Example 3 was selected to measure its stability. In a chamber, methanol-reformed gas of 380° C. and 4 atm was provided to permeate through the membrane HP537 for 24 hours. Hydrogen at 380° C. was provided on the c-LDH of the membrane HP537, and the pressure of the hydrogen was increased to 4 atm. As such, the hydrogen flux (at 4 atm) of the hydrogen permeating through the membrane HP537 was measured under the PSS of the membrane HP537 by a flow meter. Next, the chamber pressure was reduced to ambient pressure, and nitrogen was provided on the c-LDH of the membrane HP537 to drive out hydrogen. After the chamber was full of nitrogen, the pressure of the nitrogen on the c-LDH layer of the membrane HP537 was increased to 4 atm. As such, the nitrogen flux (at 4 atm) of the nitrogen permeating through the membrane HP537 was measured under the PSS of the membrane HP537 by a flow meter. The steps of providing the methanol-reformed gas for 24 hours, providing hydrogen, and providing nitrogen were repeated for several times to measure the hydrogen flux and the nitrogen flux, respectively. The above cycle was repeated for 9 days, and the hydrogen flux and the nitrogen flux of the membrane HP537 at everyday were shown in Table 8. In FIG. 8, the hydrogen flux and the nitrogen flux of the membrane in different days were stable. Note that the carbon monoxide and methane in the methanol-reformed gas have been considered toxic to palladium in this field. However, the carbon monoxide and methane in the methanol-reformed gas would not damage the membrane or shorten the membrane lifespan.

It will be apparent to those skilled in the art that various modifications and variations can be made to the disclosed methods and materials. It is intended that the specification and examples be considered as exemplary only, with the true scope of the disclosure being indicated by the following claims and their equivalents.

What is claimed is:

1. A membrane, comprising:
a porous support;
a hydrogen permeation layer on the porous support; and
a calcinated layered double hydroxide (c-LDH) layer on the hydrogen permeation layer.

2. The membrane as claimed in claim 1, wherein the porous support comprises stainless steel, ceramic, or glass.

3. The membrane as claimed in claim 1, wherein the porous support has pores filled with filling particles, the porous support has a surface modified by another c-LDH layer, or a combination thereof.

4. The membrane as claimed in claim 1, wherein the hydrogen permeation layer comprises palladium, silver, copper, gold, nickel, platinum, aluminum, gallium, indium, thallium, germanium, tin, lead, antimony, bismuth, or a combination thereof.

5. The membrane as claimed in claim 1, wherein the hydrogen permeation layer has a thickness of 1 micrometer to 100 micrometers.

6. The membrane as claimed in claim 1, wherein the layered double hydroxide has a chemical structure of [M^{II}₁₋ₓM^{III}ₓ(OH)₂]Aⁿ⁻_{x/n}.mH₂O,
wherein M^{II} is Mg²⁺, Zn²⁺, Fe²⁺, Ni²⁺, Co²⁺, or Cu²⁺;
M^{III} is Al³⁺, Cr⁺, Fe³⁺, or Sc³⁺;
Aⁿ⁻ is CO₃²⁻, Cl⁻, NO₃⁻, SO₄²⁻, PO₄³⁻, or C₆H₄(COO⁻)₂; and
x is 0.2 to 0.33.

7. The membrane as claimed in claim 6, wherein part or all of M^{II} is replaced with Li⁺.

8. The membrane as claimed in claim 1, wherein the c-LDH layer has a thickness of 1 micrometer to 50 micrometers and an interlayer spacing of 2.89 Å to 3.64 Å.

9. The membrane as claimed in claim 1, wherein the c-LDH layer comprises CO₃²⁻ functional group.

10. A method for filtering gas, comprising:
providing a membrane, wherein the membrane includes:
a porous support;
a hydrogen permeation layer on the porous support; and
a calcinated layered double hydroxide (c-LDH) layer on the hydrogen permeation layer;
providing a hydrogen-containing mixture gas on the c-LDH layer; and
collecting hydrogen under the porous support,
wherein the hydrogen sequentially permeates through the c-LDH layer, the hydrogen permeation layer, and the porous support.

11. The method as claimed in claim 10, wherein the formation of the c-LDH layer includes:
forming a layered double hydroxide on the hydrogen permeation layer,
heating the layered double hydroxide to 300° C. to 500° C., thereby forming the c-LDH layer.
